(19) United States
(12) Patent Application Publication
(10) Pub. No.: US 2013/0232236 A1
(43) Pub. Date: Sep. 5, 2013

(54) NETWORK BASED DYNAMICALLY UPDATING ELECTRONIC FLIP BOOK SERVER DEVICE

(71) Applicants: M. Vennimalai, Chennai (IN); Sarada Vennimalai, Chennai (IN)

(72) Inventors: M. Vennimalai, Chennai (IN); Sarada Vennimalai, Chennai (IN)

(21) Appl. No.: 13/988,330

(22) PCT Filed: Oct. 10, 2011
(86) PCT No.: PCT/IN11/00706

§ 371 Date: May 18, 2013

(30) Foreign Application Priority Data
Nov. 19, 2010 (IN) 3481/CHE/2010

(51) Int. Cl. H04L 29/08

(52) U.S. Cl. CPC H04L 67/02
USPC 709/219

(57) ABSTRACT

Network based dynamically updating electronic flip book server device for retrieving data stored in a database located in a central server, comprising
a. means for dynamically collecting the complete set of up to date and relevant data from data base;
b. means for formatting the said data for appropriate collation;
c. means for processing and supplying the said data on a monitor screen as e-book, to an authorized user for accessing/demand to view said data.

In this device the authorized user may access the data through an intranet browser located within the network server. Alternatively the authorized user may access the said data through the internet from an access located outside the server network. Further the authorized user may search the stored data through the said device for specific key words which he may be require. This invented device presents the patient's Medical Record in a page wise file format that doctors and nurses are used to. Each page can be accessed by flipping through the pages in a file/book, by the click of the mouse. Medical records captured through various forms in a computer for Medical facilities, are collected and published into an eBook by this server device, which works dynamically and collects information captured at various points of care and publishes the complete medical record at the time when called for. The eBook provides a format for viewing information page wise as in a physical file, duly updated and complete up to the time of viewing.

This invention relates to a network based dynamically updating electronic flip book server device and more particularly the invention relates to a server device which can dynamically collect the data from the data base, format it and then process the said data, to publish in the form of an updated eBook to a user who accesses seeking to view these information on a digital display monitor.

### PRIOR ART

In medical practice, Doctors currently view patient medical records as sheets of paper filed in a paper file. This allows for the patient's medical record to be stored and retrieved at a later time in a hospital or other medical facility. The information on this patient medical record typically consists of
1. Doctors/Nurses observations and clinical findings
2. Prescriptions
3. Lab test requests and results
4. Imaging results—X-Ray, Scans, ECG, etc.

With the advent of computerization, much of the patient's medical information is captured directly into the computer application and is not recorded on paper.

In Medical Facilities that use an electronic system, patient medical information is stored in the computer and not on paper. Doctors using such a system view the patient's medical record on the computer screen and do not require a paper file with the patient's medical records.

While there are other softwares to publish eBooks, this is done by a user when data to be published is ready. The concept is to publish an eBook to many users with data accurate up to a certain point in time—such as monthly magazines, weekly newsletters or even daily newspapers.

In all these scenarios, the data is collected and the eBook software publishes the eBook when specified to do so by the publisher. When a user views an eBook the information displayed in that eBook is only updated at the time the eBook was published by a publisher.

### DRAWBACKS IN THE PRIOR ART

Typically computers that retrieve this patient medical information from the database and display it on the Monitor in various forms such as word format, spreadsheets (excel files), web portals, or other formats is quite different from the currently used paper file. This form of information display presents some problems to Doctors, Nurses and other care givers. Traditionally they have seen patient information in a file, where additional information is added/inserted into the file and users can flip through a file to see all information related to the patient.

With the advent of computers and their increased application in various avenues in particular the medical field, viewing the same information on the computer as electronic medical record, but in a different format, requires significant adjustment and training for these medical personnel. It is a bigger problem where consultants visit multiple medical facilities to treat patients admitted there. Viewing and understanding information on different systems used by different Medical facilities is a challenge for Doctors and involves significant training and expense of time and money in operating the software or the operating system. The present invention does away with this and makes it very easy for the Users to access the data by flipping through the pages in a physical file/book through just the click of a mouse.

Current forms of information display can also be incomplete and non-user friendly, as doctors unfamiliar with the format of information accessibility/display, may miss critical or vital information while viewing the patient records to decide on patient care.

eBooks which are a viable option to provide information in an easy to read format, are published at specific time intervals with the information available up till that point in time. Therefore by their nature currently available eBooks cannot provide a user with all available information when the eBook is viewed.

### FIELD OF THE INVENTION

The present invention relates to a device for dynamically collecting, formatting & publishing all available and relevant data as an electronic book/eBook in a server to a user who seeks such data from multi input points. Computer applications connected to the server/device collect data from multi input points. This data so collected is processed and stored in the server. It is then published or projected by the server as and when required for review or use by any User when he seeks to view such data. The end result of the invention thus provides a complete, usable and comprehendible report in a book format on the computer screen, to the User accessing the Data through the particular network server/device.

### STATEMENT OF INVENTION

Thus according to this invention the network based dynamically updating electronic flip book server device for retrieving data stored in a database located in a central server, comprises of
a. means for dynamically collecting the required data from the data base;
b. means for formatting the said data for appropriate collation;
c. means for processing and supplying the said data on a monitor screen as an electronic book or e-book, to an authorized user for accessing/demand to view the said data.

Thus according to another feature of this invention in this network server device, the authorized user may access the said data through an intranet browser located within the network server.

Thus according to yet another feature of this invention in this network server device, the authorized user may access the said data through the internet from an access located outside the server network.

Thus according to yet another feature of this invention in this network server device, the authorized user may search through the stored data using the said device, for specific key words that may be of importance to him.

The invention will now be described in greater detail with reference to the accompanying drawing wherein,

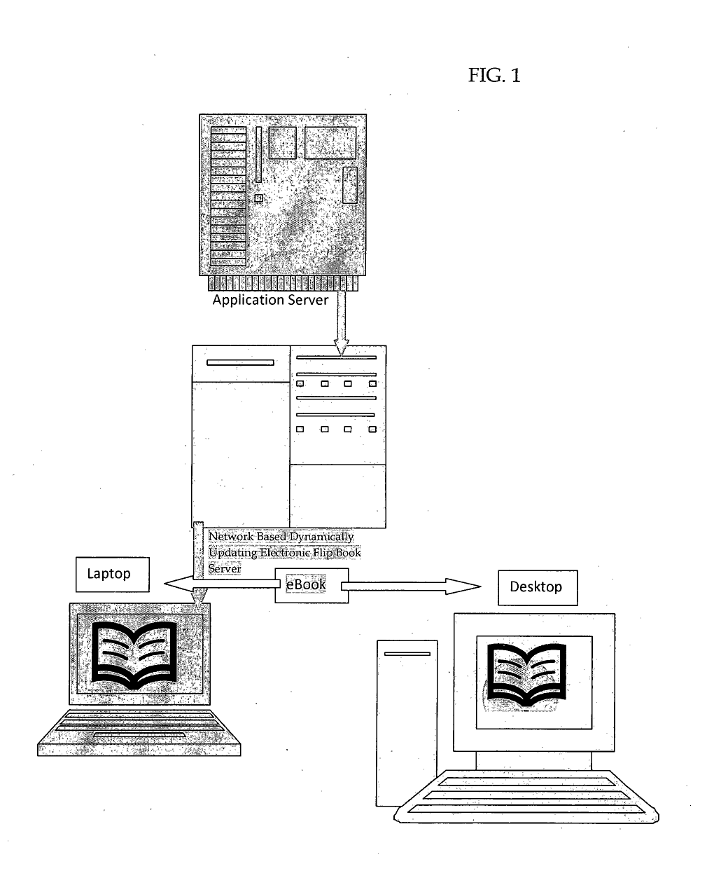

FIG. 1 shows the total architecture drawing of the present invention.

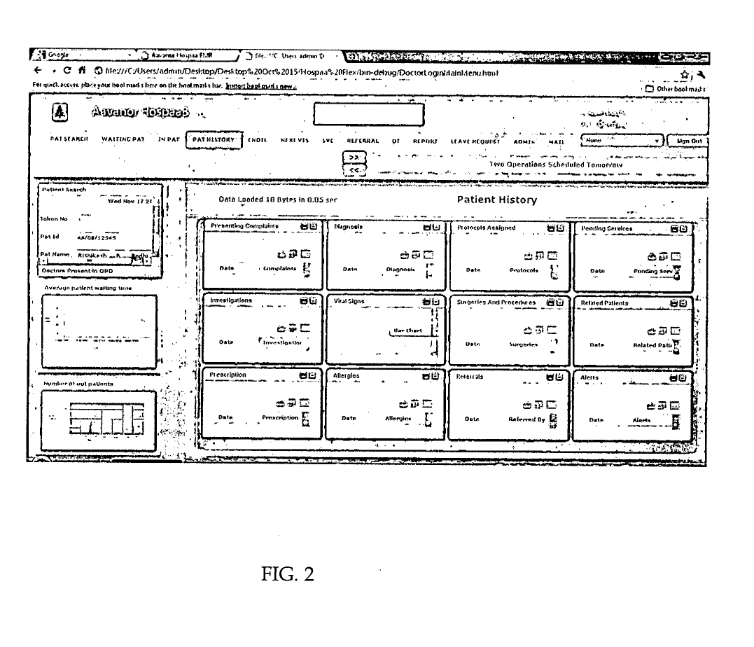

FIG. 2 shows the end result display of existing prior art.

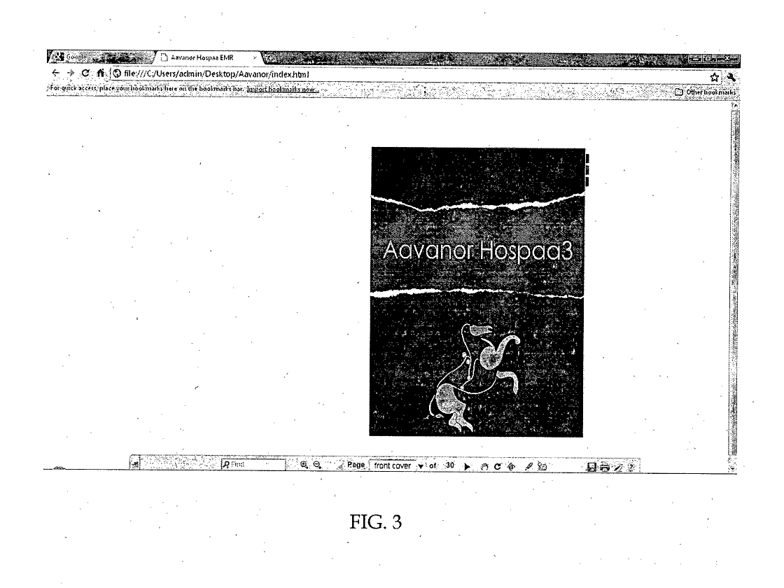

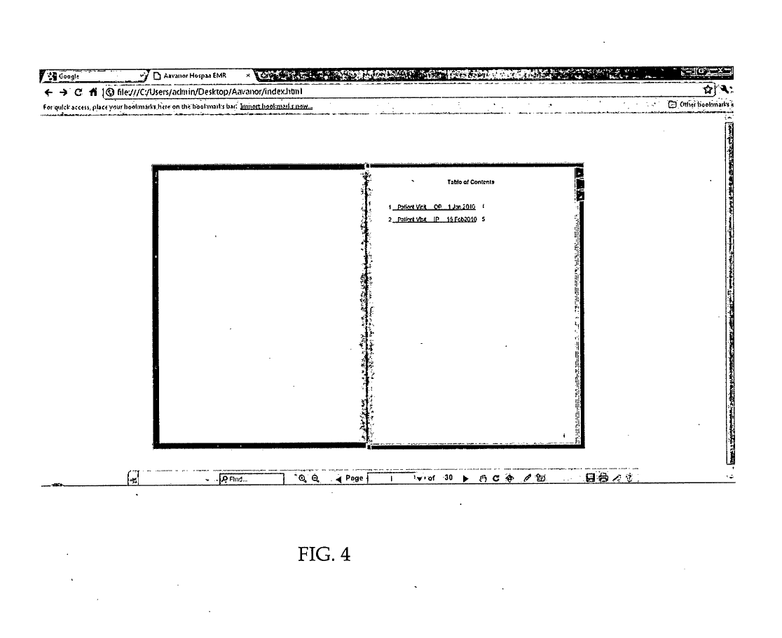

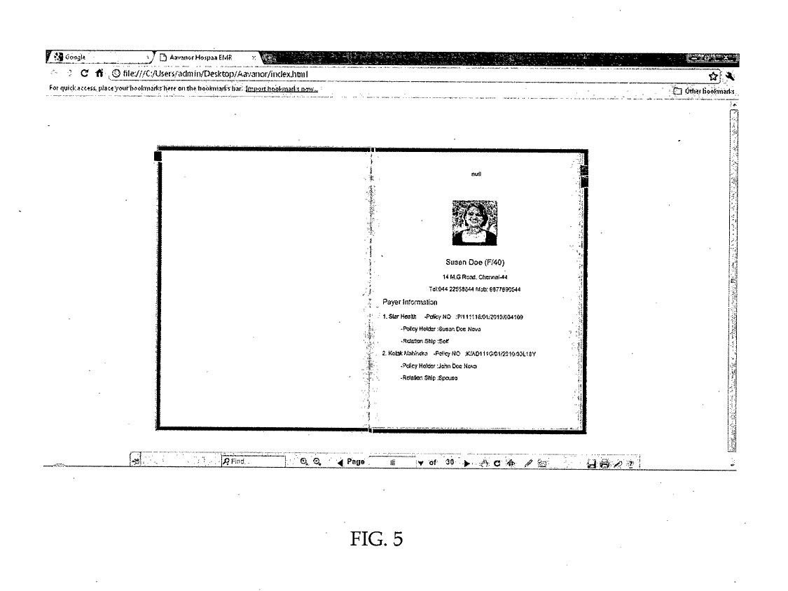

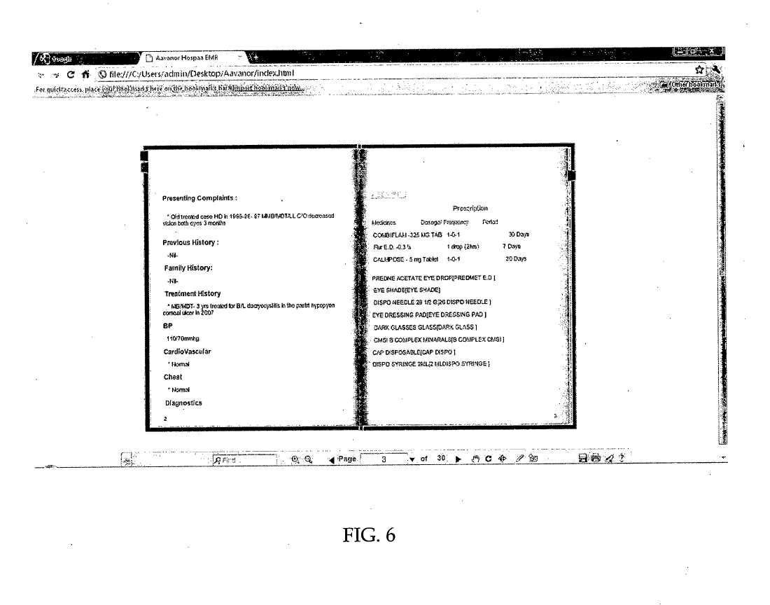

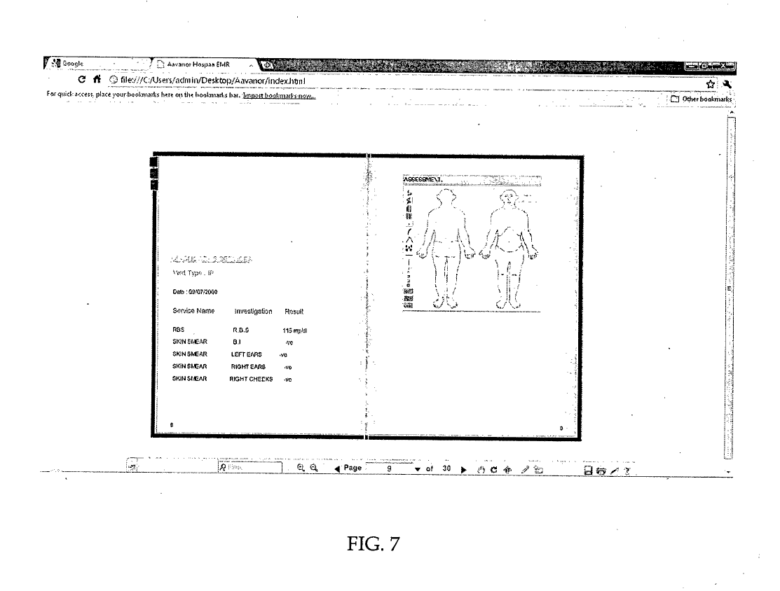

FIGS. 3 to 7 show the end result display according to this invention.

### DESCRIPTION OF THE INVENTION

The invention overcomes the problem of complexity and unfamiliarity that Care givers face when using an Electronic Medical Record. Care givers are Doctors, Physiotherapists, Nurses, Lab Technicians, Finance and Administrative staff.

The invention presents the patient's Medical Record in a page wise file format that doctors and nurses are used to. Each page can be accessed as by flipping through the pages in a book, by the click of the mouse. Medical records captured through various forms in a computer application for Medical facilities, are collected and published into an eBook by this invented server device.

This work is done dynamically and server device collects information captured at various points of care and publishes the complete medical record at the time that it is called for.

Thus the Care giver is able to see the complete patient medical record, up-to-date with all information recorded at multiple places in the medical facility.

The present invention collects information about the patient, stored in multiple tables and columns in the application database.

The dynamically updated eBook provides Users with a format for viewing information page wise as in a physical file, duly updated and complete up to the time of viewing, by the click of a mouse, as already mentioned above. The data thus available is updated and complete in all respect till the time of viewing by the User whether it is a doctor or any other user. It also enables better, user friendly, faster and safer for processing, accessing, availability and viewing, of patient medical information, without missing out on any patient related information. This is the inventive step which is the technical advancement over the existing prior art.

The invention therefore relates to a dynamically updating, eBook using totally modified and highly enhanced flipbook technology in the network server device.

This information is inserted into the said eBook in two places.
1. Date wise records—where all data is entered into the record on the basis of chronological sequence of capture according to the date.
2. Subject wise records—where all data is entered into ‘chapters’ where specific types of data are collated—such as all prescriptions in one chapter, all results from the clinical labs in a separate chapter, and the like.

The eBook is automatically updated and published whenever a user requests to view the patient record, which is the technical advancement, over the existing prior art where the eBook is published only once and will not be updated continuously.

Some information is manipulated when it is extracted from the database to display it in a combined or ‘summary’ form that is easier to comprehend, e.g. all medicines prescribed may be displayed on a chart indicating time lines, rather than singly.

This information is then automatically published as an ‘eBook’.

Advantages of the present invention over the existing prior art:

1. Traditional ‘eBooks’ are not dynamic. Currently ‘eBooks’ are published by a ‘publisher’ who collects data, verifies, formats while publishing it as an ‘eBook’, which is unsuitable for the requirements of a medical facility as the file must be updated and complete at all times. There are no ‘dynamically updating eBooks’ available in the market, whereas the server device claimed is an automatically and dynamically updating eBook type which makes it as a new invention. This technology allows it to automatically take the data from the database, follow specific rules for formatting of this data for display and process and then publish it as an eBook that contains up-to-date information, in a better formatted, convenient for the display while viewing by the User.

2. Further, the present invention can be used in a number of scenarios other than Healthcare, such as for education, auditing purposes, banking, reporting in all industries, and the like.

3. It will be useful for a number of Software applications where data from multiple sources has to be viewed by ‘non-regular’ users of the system. These ‘Non-Regular’ users would find it easier to digest data presented in the form of an eBook.

4. Where ever reports are regularly reviewed by users in paper files, the present invention would be a very useful option for software application builders to present the same users with a computer report in a required and familiar format.

The invention has been described with reference to specific embodiment. Further the description is only illustrative of the present invention. It is not intended. that the invention be limited. or restricted thereto. Alternative embodiments of the invention will be possible as apparent to one skilled in the art, by way of substitution, alterations and modifications that come within the scope of the following claims, to which the present invention is susceptible without departing from the spirit and scope of the invention.

1-5. (canceled)

6. A system for dynamically configuring data on a server and transmitting said data as an electronic book over a network, wherein said server dynamically collects said data from a plurality of databases and formats said collected data in a pre-defined format to generate said electronic book, and wherein a user browser receives said formatted data in form said electronic book and displays said electronic book.

7. The system of claim 1, wherein said system is configured to process said data in real-time and format said real-time data at run time to generate said electronic book.

8. The system of claim 1, wherein said user is authenticated before accessing said electronic book.

9. The system of claim 1, wherein said user accesses said data through said browser, wherein said browser is located within said network.

10. The system of claim 1, wherein said user accesses said data through said browser, wherein said browser is located outside said network.

11. The system of claim 1, wherein said user searches said electronic book for identification of specific keywords.

12. A device for receiving and presenting an electronic book to a user, wherein said electronic book is generated based on dynamic configuration of data on a server and transmission of said configured data as said electronic book over a network to said device, wherein said server dynamically collects said data from a plurality of databases and formats said collected data in a pre-defined format to generate said electronic book, and wherein said device comprises a user browser configured to receive said formatted data in form said electronic book and display said electronic book.

13. The device of claim 7, wherein said server is configured to process said data in real-time and format said real-time data at run time to generate said electronic book.

14. The device of claim 7, wherein said user is authenticated before accessing said electronic book.

15. device of claim 7, wherein said user accesses said data through said browser, wherein said browser is located within said network.

16. The device of claim 7, wherein said user accesses said data through said browser, wherein said browser is located outside said network.

17. The system of claim 7, wherein said user searches said electronic book for identification of specific keywords.

18. The device of claim 7, wherein said one or more databases are configured at multiple locations.

19. The device of claim 7, wherein said server processes said data and generates said electronic book based on input from said user.

20. The device of claim 7, wherein said pre-defined format is designed by said user.

21. The device of claim 7, wherein said electronic book comprises multiple pages, wherein each page is retrieved from one or a combination of said databases.

22. The device of claim 7, wherein said data is stored in said databases in the form of tables and columns.

23. The device of claim 7, wherein said electronic book comprises medical information of a patient.
The Applicant submits that the foregoing amendments add no new matter to the application.
